(19) United States
(12) Patent Application Publication
(10) Pub. No.: US 2009/0075713 A1
(43) Pub. Date: Mar. 19, 2009

(54) E-INK BINGO DISPLAY

(76) Inventors: Michael W. Hartman, Reno, NV (US); Justin Goodman, Sparks, NV (US)

Correspondence Address: DILLON & YUDELL LLP, 8911 NORTH CAPITAL OF TEXAS HWY, SUITE 2110, AUSTIN, TX, 78759, US

(21) Appl. No.: 11/857,935

(22) Filed: Sep. 19, 2007

(51) Int. Cl. A63F 13/00

(52) U.S. Cl. 463/19

(57) ABSTRACT

A system, method and computer-readable medium for implementing gaming systems and devices using portable e-ink bingo display devices. In one embodiment, an electronic game device includes a display controller adapted for generating a game face and a display assembly that displays the generated game face. The display assembly includes an electronic ink display sheet on which the generated game face is displayed, and a dauber interface that converts dauber input signals to electronic signals received by the display controller to adjust the display of the game face on the electronic ink display.

### BACKGROUND OF THE INVENTION

1. Technical Field

The present invention relates generally to gaming systems and devices, and in particular to a portable device for displaying interactive games. More particularly, the present invention relates to a portable gaming display device incorporating touch screen and electronic ink technology for electronically displaying bingo cards.

2. Description of the Related Art

Bingo and bingo-like games are well-known games of chance in which each player's chances of winning depend on randomly selected numbers. Bingo conventionally involves a caller who draws the randomly selected numbers, often printed on balls, and calls out the drawn numbers to a group of players. Any called number may match entries contained on pre-printed patterned arrays, commonly called “faces,” displayed on bingo cards sold to players. The most popular face is a 5×5 array in which all but the center entry is a number. The letters B-I-N-G-O are displayed above the array, such that each letter is aligned with a vertical column of the numeric entries. A one or two-digit number generally from 1 to 99 appears in every array entry on the bingo card except the center entry, which is designated as a “free” play entry. The randomly generated numbers are obtained from a central source. The central source may be, for example, a set of bingo balls from which random numbers are drawn. The number of balls corresponds to the range of alphanumeric combinations available on the bingo cards. Namely, each ball includes one of the letters B-I-N-G-O and one number from the available range of numbers. From an air-ball machine or a box, a caller randomly selects balls sequentially one at a time and announces the letter and number appearing on each of the balls. Players having bingo card faces with letter/number combinations matching the balls called, mark the corresponding matches using an ink dauber. In one standard version, the word “bingo” is called out by a player when he/she discovers that five numbers have been daubed in a straight line either vertically, horizontally or diagonally. Each player may play multiple bingo cards given that playing more cards increases the player's chances of winning a given game.

A variation of the traditional bingo game utilizes electronic bingo card displays rather than the traditional printed paper bingo cards. In these electronic bingo-type games, each bingo card is represented by a data structure specifying the numeric entries in the bingo card face arrays. This type of electronic bingo may be played using player stations connected via a communications network to a centralized game controller. The game controller stores the bingo card representations and electronically distributes the bingo card representations to the player stations. The player stations display the bingo card representations and include user controls that enable the players to select matching numbers announced during the game. Electronic bingo games may be played at a much faster pace than is practical with traditional paper bingo. Furthermore, electronic bingo dispenses with the cumbersome and wasteful use of paper bingo cards and enables a centralized controller to control a bingo game played by players at player stations distributed across a number of different bingo establishments.

While providing many advantages, it may be desirable for electronically displayed bingo to retain the basic characteristics of a bingo-type game. Prominent among such traditional characteristics is that the game be played with predefined cards or card representations which the players match against a randomly generated master game indicia sequence. Prior art electronic bingo designs generally employ design features that are technically convenient but do not adequately reproduce or simulate the conventional bingo game experience and therefore have not gained widespread popularity. Notable among the prior art designs in this area disclosed in U.S. patents are:

Richardson, in U.S. Pat. Nos. 5,007,649; 5,043,887; 5,054,787; and 5,072,381 teaches an electronic bingo system in which a plurality of arrays of indicia, each corresponding to a separately displayable face, are downloaded from a central computer into a memory portion of a player's electronic game board. A floor walker's validation terminal is used to validate a winning combination by means including receiving a unique game-specific code (which may conveniently be a serialized number known as a “permutation number” associated with a particular algorithm for generating the set of all permutations of allowable indicia) from the allegedly winning game board. Richardson's game board comprises a card display and a keypad. The use of the keypad to enter called numbers is not simulative of the physical marking of paper cards. Moreover, Richardson's game board displays only a single face and thereby fails to facilitate N-on play.

Itkis, in U.S. Pat. No. 5,478,084, teaches a mechanical bingo machine that displays multiple playable faces at one time (e.g., a 6-on card) and that uses a permanent magnet to move suspended ferromagnetic particles from a hidden side of a display board to a visible side in order to make a white-to-black transition, simulative of an ink dauber being used, to mark called numbers.

Frain, in U.S. Pat. No. 5,230,514, teaches an electronic game board comprising 2-on to 18-on card displays and a plurality of player input means, including means to select a special game. Frain provides no way of changing the display on any one of the boards. A player who wants a different set of numbers is required to turn her board in for another one.

Matsumoto et al., in U.S. Pat. No. 5,755,619, show a casino bingo apparatus in which each player uses a touch-screen terminal hard-wired to a central unit. The central unit keeps score and uses conventional bingo balls to generate called numbers. The required wiring makes installation of Matsumoto's expensive and essentially requires a dedicated facility.

It can therefore be appreciated that a need exists for a method, system, and computer program product for displaying bingo face representations in a manner overcoming the foregoing problems encountered in the prior art. The present invention addresses this and other needs unresolved by the prior art.

### SUMMARY OF THE INVENTION

A system, method and computer-readable medium for implementing gaming systems and devices using portable e-ink bingo display devices are disclosed herein. In one embodiment, an electronic game device includes a display controller adapted for generating a game face and a display assembly that displays the generated game face. The display assembly includes an electronic ink display sheet on which the generated game face is displayed, and a dauber interface that converts dauber input signals to electronic signals received by the display controller to adjust the display of the game face on the electronic ink display.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a gaming system adapted for implementing the portable electronic ink bingo display of the present invention;

FIG. 2 illustrates a portable electronic ink bingo display device in accordance with one embodiment of the present invention;

FIG. 3 depicts an electronic ink display assembly that may be utilized as a standalone unit or may be incorporated in the display device illustrated in FIG. 2;

FIG. 4A illustrates an overhead view of an activated electronic ink bingo card in accordance with one embodiment of the present invention;

FIG. 4B depicts a partial cross-section view of the electronic ink bingo card shown in FIG. 4A;

FIG. 5 is a high-level block diagram illustrating electronic and logic modules contained in an electronic ink display device in accordance with one embodiment of the present invention; and

FIG. 6 is a high-level flow diagram depicting steps performed during bingo card display initialization and use in accordance with one embodiment of the present invention.

### DETAILED DESCRIPTION OF ILLUSTRATIVE EMBODIMENT(S)

The present invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention. Furthermore, when used and unless otherwise stated, terms such as “horizontal,” “vertical,” “upper,” “lower,” “front,” “back,” “over,” and “under,” and similar position related terms are not to be construed as limiting the invention to a particular orientation. Instead, such terms are to be construed only on a relative basis with respect to the accompanying depicted embodiments.

The present invention is generally directed to electronic bingo game devices, assemblies, and systems that dispense with the need for the time and material expenditures as well as the game usage inflexibility associated with conventional paper card bingo systems. A portable electronic display device employing an electronic ink display overcomes many problems associated with paper bingo cards while also addressing problems associated with conventional electronic bingo displays.

It will be recognized by those skilled in the gaming arts that the game traditionally known as bingo is only one of a number of bingo-like games of chance. The present invention applies to the general category of bingo-like games in which a player views a proximally displayed pattern of indicia that comprises a subset of all such playable indicia, monitors a randomly or otherwise selected sequence of indicia from the set of all possible indicia supplied by a common source or controller, marks those indicia from selected sequence that appear on his/her array(s), and receives a prize if a correctly marked subset of the randomly selected sequence corresponds to a characteristic winning pattern of the indicia disposed on his/her local display. Such bingo-like games are further characterized in that each player submits payment for each proximally displayable array of indicia prior to the sequence of indicia being selected.

The present invention is further directed to electronic equipment for playing a bingo-like game in a manner that closely simulates the conventional game of bingo played with paper cards while also enabling a more efficient bingo game experience to accommodate today's players who are increasingly accustomed to more fast-paced entertainment. The present invention is further directed to a portable electronic bingo display device that may include a tracking mechanism to prevent players from missing a winning pattern when playing multiple cards and multiple bingo-like game types. In this manner, the invention aids novice players and players with physical disabilities who otherwise may be at a competitive disadvantage in playing conventional paper card bingo.

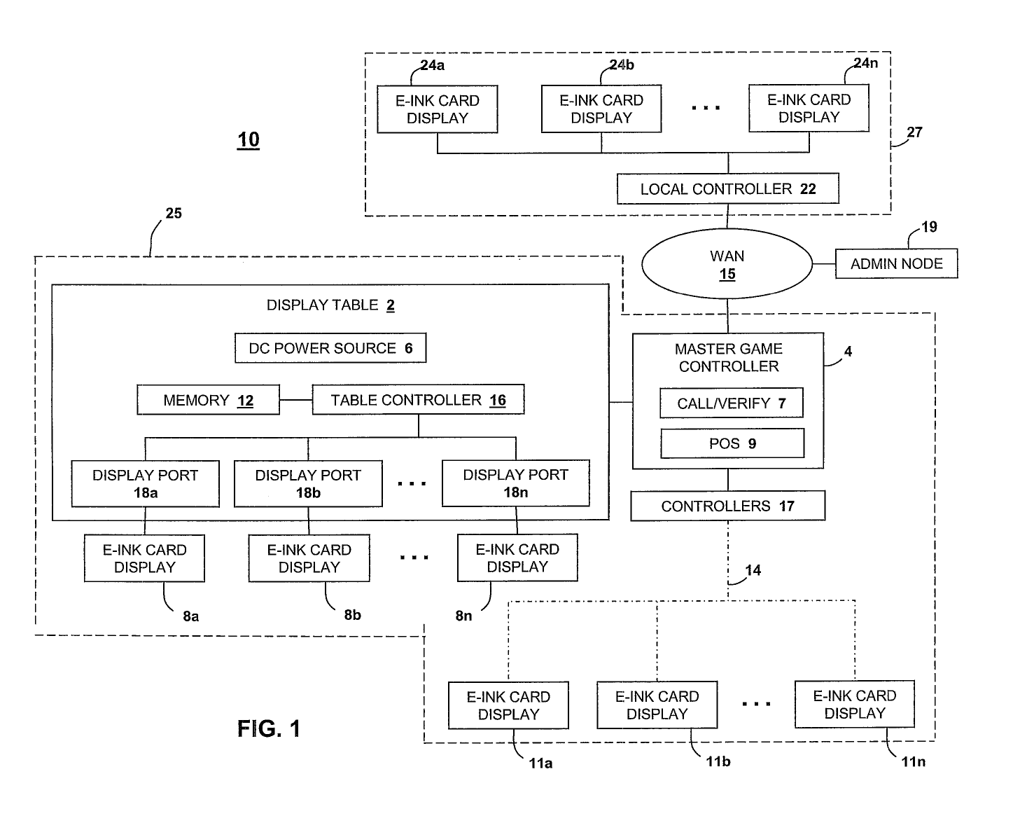

With reference now to the figures, wherein like reference numerals refer to like and corresponding parts throughout, and in particular with reference to FIG. 1, there is depicted a gaming system 10 adapted for providing portable electronic bingo displays utilizing electronic ink in accordance with the invention. Gaming system 10 generally comprises a master game controller 4 that cooperates with a number of other components to enable bingo players, possibly at multiple different, mutually remote gaming sites, to co-participate in bingo games. As shown in FIG. 1, master game controller 4 is located within a particular gaming site 25 that contains devices and components enabling players to participate in bingo games initiated and controlled by game controller 4. Master game controller 4 preferably includes game server functionality and is communicatively coupled to a number of electronic bingo display devices within and outside gaming site 25. In one embodiment, master game controller 4 comprises a caller/verifier unit 7 that performs indicium call and verification functions and further includes a point of sale unit 9 for receiving and managing card face sales information.

In a preferred embodiment, and as explained in further detail below, the electronic bingo display devices comprise a portable electronic paper or electronic ink (e-ink) display device. The e-ink design enables the display devices to closely simulate the feel and function of traditional paper bingo cards while incorporating many of the advantages derived from electronically coupled, controlled, and networked display devices.

The e-ink display devices within gaming system 10 include e-ink display cards 8a-8n, 11a-11n, and 24a-24n that enable players to co-participate in centrally controlled bingo games using different gaming interfaces at possibly difference game sites. In this manner, players at different gaming facilities may be grouped together for a given bingo game administered by master game controller 4. Grouping together players from different gaming facilities for commonly played bingo games enables different bingo games to be played rapidly and minimizes the time that players must wait to receive bingo game results.

Master game controller 4 includes electronic and program modules for rapidly grouping players and/or game type/play requests and starts games sequentially and concurrently so that multiple games may be in play at any given time. That is, once a first group of players and/or game play requests have been received by gaming system 10, the system proceeds via master controller 4 to commence and administer a bingo game for the first group of players or game play request while also grouping players or game play requests for other bingo games without waiting for the ongoing game(s) to terminate. In this manner, gaming system 10 may concurrently administer numerous bingo games displayed by many thousands of electronic bingo displays at various remote locations throughout the gaming system.

Regardless of the rapid, automated game control and display facilitated by gaming system 10, the underlying game preferably adheres to the basic game principles characteristic of a standard bingo game. Such basic bingo game principles include assigning each player one or more bingo cards or bingo card representations, daubing or otherwise marking all bingo cards in play for matches with a randomly generated sequence of typically alphanumeric indicia, and determining the winning card(s) as the first card(s) in the game to match the sequence of designations to produce the pre-specified game winning pattern.

While not expressly depicted in FIG. 1, master game controller 4 typically comprises a data processing system including basic components such as one or more processors, nonvolatile and volatile memory, a user interface, and a communications interface, all coupled to a system bus. The user interface for master game controller 4 may include a number of different devices such as a keyboard, a pointing device, touch screen device, etc. In the alternative to an integrated user interface, a user interface for master game controller 4 may be provided through a separate, possibly remote data processing system in communication with the controller. Regardless of the particular configuration of gaming system 10, game controller 4 functions to group players for participation in bingo games offered through the system, generates or otherwise obtains randomized sequences of indicia to be matched with indicia on bingo cards or bingo card representations, identifies or verifies intermediate and final responses from players and bingo game results, and communicates the responses/results to the various gaming sites.

The sequence of randomized indicia may be, for example, a ball draw in which balls or representations of balls each having a number and letter are randomly selected sequentially. It will be appreciated that this type of ball draw or other sequence of randomized indicia may be produced by a random number generator module or any other suitable module or device within master game controller 4, and not necessarily a physical ball draw device.

Gaming system 10 further includes network connectivity provided by a wide area network (WAN) 15 to a remote gaming site 27 and remote nodes such as node 19. Node 19 may be an administrative node having authorized access to control features and mechanisms within master game controller 4 and other control nodes within the depicted gaming system 10. Remote gaming site 27 includes a local game controller 22 communicatively coupled to multiple e-ink bingo card displays 24a-24n. While not expressly depicted in FIG. 1, it will be appreciated and understood by those skilled in the art that a network interface may be required to couple local controller 22 to WAN 15. It will be further appreciated that local controller 22 may comprise a data processing system having a similar architecture as that previously described for master game controller 4. Regardless of its specific architecture and configuration, local controller 22 serves to generate, transfer and relay information between one or more of e-ink card display devices 24a-24n and master game controller 4. In a preferred embodiment, and depending on desired system control scaling, local controller 22 may also include electronic and program modules for grouping players and game type/play requests received from among e-ink display devices 24a-24n. For a case in which master game controller 4 serves and administers large numbers of games and/or during a time of game activity, local controller 22 may assume the functions associated with grouping players and game play requests from e-ink bingo display devices 24a-24n, generate a random number sequence (e.g. a simulated ball draw), determine display device responses and game results, and return responses/results to the display devices. Additionally, local controller 22 may be configured to perform the tasks normally performed by master game controller 4 in the event of a degradation or disruption in the communications link between local controller 22 and master game controller 4.

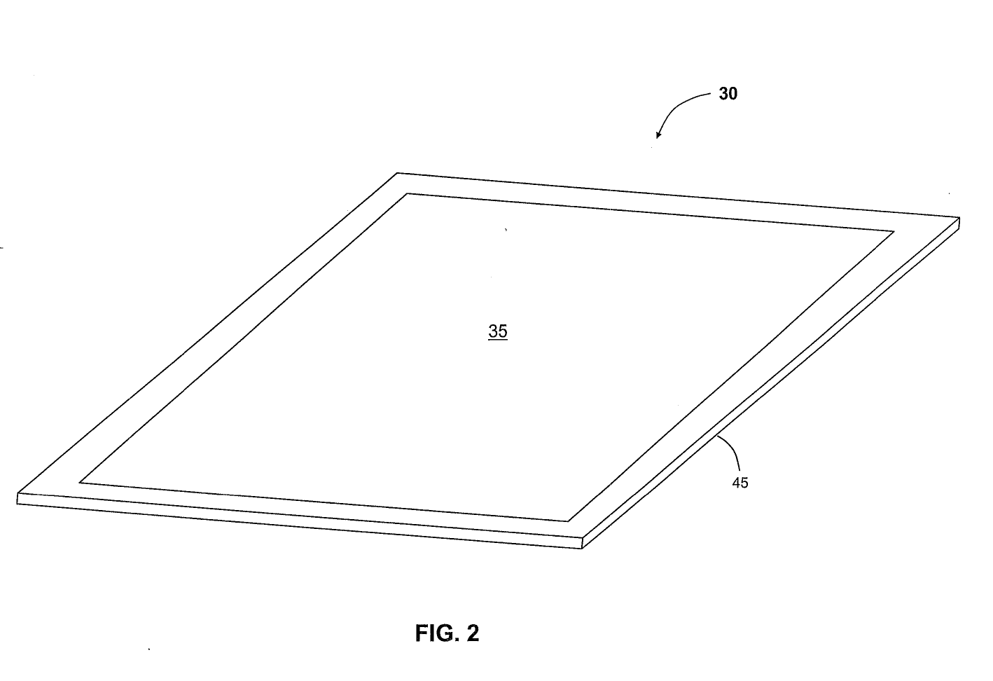

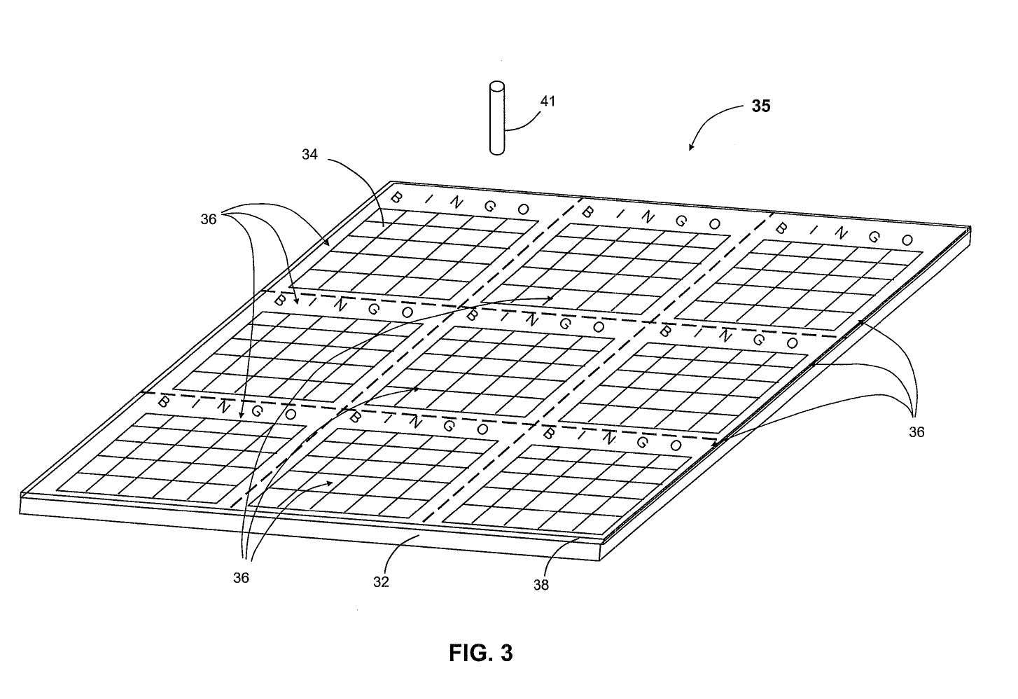

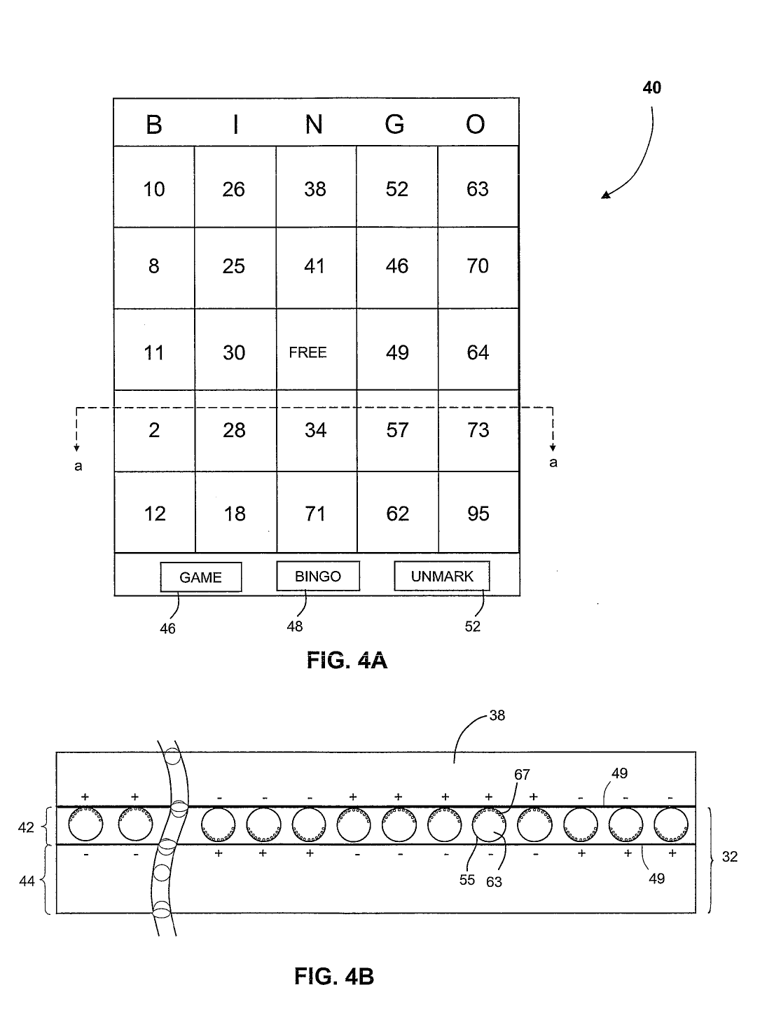

In addition to remotely situated e-ink bingo display devices within gaming site 27, gaming system 10 includes multiple e-ink bingo display devices 8a-8n and 11a-11n situated locally within gaming site 25. Display devices 8a-8n and 11a-11n are preferably lightweight and readily portable devices that may be hand-carried by players to desired locations and game ports within gaming site 25. As depicted and explained in further detail below, the display devices fundamentally include an electronic display surface on which bingo card representations may be displayed. In accordance with the depicted embodiment, the display devices utilize an e-ink display assembly (depicted in FIGS. 2, 3, 4A, and 4B) that provides a high-resolution image on a lightweight substrate, similar to paper in thickness and pliability, and with minimal power supply requirements. The details of the displayed bingo card representations are explained in further detail below with reference to FIGS. 3 and 4A.

In one aspect, the portable bingo display system of the present invention encompasses wireless connectivity that enables the display devices to be freely moved prior to and during a given bingo game session in a manner similar to the familiar mobility of paper bingo cards. To this end, and as shown in FIG. 1, display devices 11a-11n are communicatively coupled to master game controller 4 via respective display controllers 17 and a wireless link 14 which in one embodiment may comprise RF transceiver functionality within master game controller 4 and each of display devices 11a-11n. Given the necessity of highly reliable wireless transmission, wireless link 14 may include transmission/repeater backup and redundancy situated within gaming site 25.

In another aspect, the portable bingo display system may alternately employ portable bingo display devices that may be coupled to master game controller 4 via a player station apparatus such as display table 2. Namely, display table 2 includes multiple display ports 18a-18n that provide communicative connectivity with master game controller 4 and optional power supply from a DC power source 6 for display devices 8a-8n.

The particular configuration of devices shown in FIG. 1 is exemplary and should not be construed as necessarily limiting the scope of the present invention. In an alternate embodiment, a gaming system may include or omit some or all of the separate components within gaming sites 25 and 27 so that e-ink bingo display devices 24a-24n communicate directly with master game controller 4 via WAN 15. Also, the various gaming sites and facilities may be divided into subsystems each having a respective game controller to enable varying levels of processing scaling and/or independence with respect to the master game controller. In this manner, gaming system 10 could be configured such that a single e-ink bingo display device may be hosted by any one of multiple available game controllers.

FIGS. 2-5 illustrate various aspects and components of a portable bingo display device such as may be implemented as one or more of display devices 8a-8n, 11a-11n, and 24a-24n. Referring to FIG. 2, there is illustrated a perspective view of a portable e-ink bingo display device 30 in accordance with one embodiment of the present invention. As shown in FIG. 2, e-ink bingo display device 30 comprises a substantially rectangular display assembly 35 contained within a body member 45. As depicted in further detail with reference to FIGS. 3, 4A, and 4B, display assembly 35 preferably comprises an electronic display element enabling a bingo card representation to be displayed in a manner substantially impervious to low lighting conditions and view angle. Furthermore, the display element is mounted in or on a sheet or film substrate that is similar in material characteristics to traditional paper bingo cards.

In the depicted embodiment, bingo card representations are displayable on display assembly 35 housed within a body member 45. Prior art electronic game displays are subject to failure in service when the board is exposed to liquids such as an accidentally spilled beverage during the course of play. Body member 45 therefore preferably comprises a sealed, liquid-tight housing preferable having no outer exposed metallic electrical connections extending to its surface. Integral to body member 45 or as a separate structural feature, a cover layer 38 provides a protective layer above and adjacent the display surface of display assembly 35. Cover layer 38 is a substantially transparent sheet member made of a resilient polymer or other material suitable to provide protection to the surface of display assembly 35 from exposure to liquids and direct mechanical contact.

Bingo players often play multiple faces simultaneously in an arrangement commonly called “N-on play,” where N is the number of faces being played. Bingo operators therefore often sell cards having multiple faces printed thereon. FIG. 3 depicts a more detailed view of e-ink display assembly 35 that may be a standalone unit or may be incorporated in e-ink display device 30, and in which multiple game faces may be simultaneously displayed. In the example of FIG. 3, display assembly 35 comprises a display field adapted to display an array of up to nine playable bingo faces. The illustrated display field has nine individually addressable and dynamically alterable face fields 36, each of which is adapted to display a single playable array pattern 34.

As explained in further detail below with reference to FIG. 4A, display assembly 35 may include display field control means, such as a player input response sent to a game controller such as master controller 4 or table controller 16, that enables a player to select which of the array patterns is to be displayed in the active, high resolution display provided by display assembly 35. In the illustrated embodiment, display assembly 35 provides a player with up to nine playable faces. It should be noted that many variations of playable and/or activated display field layout are possible. For a given bingo game session, a player may select the maximum available or any fewer number of faces to be played at a given time.

Whether used as a standalone unit or incorporated within a portable body, display assembly 35 is readily portable and can be readily carried by a player and used anywhere a conventional paper bingo card may be used. The portability of the device may limit continuous accessibility to an AC electrical power supply, and require that the device operate using an integral battery or other portable power supply. The device is therefore preferably designed for minimal power supply requirements in order to maximize reliable playing time. Many electronic display technologies such as LED, LCD, CRT or plasma panels are available for portable bingo game displays. In a preferred embodiment, the face fields within display assembly 35 are e-ink displays which have a substantially lower power supply requirement. As explained below with reference to FIG. 4B, the e-ink display of the invention provides an optimal display requiring power only when the displayed data within the face fields are being changed.

Another feature of a preferred embodiment is a sensing mechanism for marking an e-ink display in a manner similar to the use of conventional ink daubers in marking paper bingo cards. In one embodiment, the sensing mechanism comprises a marking means, or “dauber,” that simulates an ink dauber that is commonly used when playing bingo with paper cards. FIG. 3 illustrates one exemplary marking means in the form of a dauber 41 that is a small hand-held instrument used by a player to mark cells within the array patterns during a game. The dimensions are selected so that dauber 41 is substantially the same size and shape as traditional ink daubers. In one embodiment, dauber 41 is an inert cylindrical member having a smooth blunt end that is pressed against a target cell to indicate that cell has having been daubed. For this embodiment, display assembly 35 includes a touch screen overlay 38 that which provides a pressure-sensitive grid addressable to the corresponding underlying displayed bingo faces. In another embodiment, one or both ends of dauber 41 are magnetized such as by constructing dauber 41 with an insulative body containing a ferromagnetic material. The body material for dauber 41 is preferably a soft rubber or polymer or other material posing minimal risk of scratching or otherwise mechanically damaging overlay sheet 38 or other protective outer sheet forming the exposed outer protective layer over display assembly 35.

For the embodiment in which dauber 41 is magnetized, a Hall effect sensor (not depicted) is disposed within overlay sheet 38 or in a substrate layer (depicted in FIG. 4B) on which the e-ink display elements are supported. In this manner, when the magnetized portion of dauber 41 is held closely proximate to one of the cells within an indicia pattern array 34, the adjacent magnetic sensor provides a signal to an internal or external display controller. The display controller responds to receipt of the sensor signal by altering the visual appearance of the corresponding cell in a specified manner that designates the cell as being marked. For example, the cell may be blacked out or otherwise rendered opaque or the background color or internal pattern may be visibly altered such as by displaying an “X” over the originally displayed indicium within the cell. It will be understood that a system of the invention may be configured to use any one of many other sensing mechanisms for sensing contact or proximate presence of a simulation dauber.

With reference to FIG. 4A, there is illustrated an overhead view of an activated e-ink bingo card 40 such as may be implemented individually as a standalone unit or as one of face fields 36 in accordance with one embodiment of the present invention. E-ink bingo card 40 contains electronic display elements which, as shown in the depicted embodiment, have been activated to provide a bingo face display containing the letters B-I-N-G-O each above and aligned with corresponding columns in a 5×5 cell array pattern. E-ink bingo card 40 is shown as being activated such that the cells contain numbers that form the numeric portion of the alphanumeric game indicia utilized in typical bingo games. As is known in the art, the alphabetic portion of the alphanumeric indicia comprises the letters B-I-N-G-O that are matched with the numbers contained in the corresponding columns to form the entire indicia that are played. It should be noted that while FIG. 4A depicts e-ink bingo card 40 as having alphanumeric indicia, alternate embodiments of the invention may employ other types of symbolic indicia.

The depicted embodiment further includes features for addressing problems that may arise when players simultaneously play multiple types of bingo games as defined by different winning patterns. As known in the art, the standard winning patterns of aligning five numbers on a card horizontally, vertically, or diagonally have been supplemented by a number of other, often more complex, winning patterns. Exemplary of the additional, more complex winning patterns are “Four Corners” where winning numbers are found in every corner of the array, “Small Diamond” where four winning numbers are found encircling one cell in the array; and “Large Diamond” where winning numbers are aligned diagonally encircling a small diamond. In addition, the prevalent use of wild card numbers adds to the complexity of tracking winning patterns particularly when playing multiple faces.

Wild card numbers and the winning patterns may change for each bingo game and players must be aware of these changes and apply the corresponding rules correctly for each called number. The complexity of tracking several winning patterns for each game combined with the large number of cards played, naturally increases the chances that a player will miss noticing and marking matches between a called number and a matching pattern entry.

The e-ink display device of the present invention includes features that address these problems by facilitating a player's ability to track one or more particular bingo patterns among several variations that may be in play simultaneously. Namely, and referring again to FIG. 4A, bingo card 40 preferably provides a color-coded or pattern-coded game-indicating indicium or flag that provides a continuous or intermittently user-prompted visual cue identifying the game currently being played on the face in question. Such color or pattern-codes may simulate the different card colors or patterns printed on a paper bingo card and used to denote specified game types within a multi-game session in which that particular paper card is played. For example, the background color of bingo card 40 including the portion containing the letters B-I-N-G-O and pattern array area may be changed from a default color such as white to a coded color such as blue to designate a specified game pattern type is to be played on the displayed face. The background color designation may be determined by processing means integral to bingo card 40 or may be determined by processing means within an external display controller such as within table controller 16 or master game controller 4.

As an aid for assisting a player to determine whether a winning pattern has been achieved at any point during a game, bingo card 40 includes a game control button 46 which, when daubed or otherwise selected, provides a winning pattern display prompt to a local or external display controller. In one embodiment, the winning pattern prompt results in one or more possible winning patterns corresponding to marked cells being persistently or temporarily displayed in a manner highlighting a winning pattern that has been achieved. For example, if the game being played on bingo card 40 is “Four Corners” and the correct four corner cells containing the numbers 10, 63, 95, and 12 have been daubed, the display prompt signal resulting from selection of game control button 46 may instruct the receiving display controller to provide a visual highlight, such as a color-coded or pattern-coded indicium to each of the four corners to assist in apprising the player that a winning pattern has been achieved.

As further illustrated in FIG. 4A, bingo card 40 preferably includes additional control buttons bingo 48 and unmark 52. For circumstances in which the local game site is very large or the players are otherwise substantially dispersed or when the game includes networked participants, the tradition of calling out “bingo!” is ineffective. In such circumstances, a player recognizing a winning pattern may daub or otherwise select the control button bingo 48 to send a winning pattern signal prompt to a game controller such as master game controller 4. In response to receiving a winning pattern prompt signal, master game controller 4 preferably verifies the correctness of the player's assertion using stored card face and master sequence data.

The unmark control button 52 provides a convenient means by which a player can remove both the visual indication of and underlying game controller recordation of an inadvertently or otherwise incorrectly daubed cell. If, for example, the caller calls B11, which matches a cell on bingo card 40, and the player responds by inadvertently daubing an adjacent cell B2, the player may correct the mistake by first daubing the unmark button 52 to set the display controller in a “daubing correction” mode and then daubing the incorrectly marked cell to remove the visual and underlying data recordation.

The display, and particularly the dynamically alterable numeric indicia are displayed by bingo card 40 using e-ink, sometimes referred to as electronic paper or E-paper technology. E-ink is an emerging display technology developed to overcome some of the limitations of conventional electronic display devices such as LCD and plasma screens. E-ink displays closely simulate the appearance of ink on paper. In contrast to conventional flat panel displays which use a backlight to illuminate its pixels, an e-ink display reflects ambient light in a manner substantially identical to ordinary paper. E-ink displays are also capable of holding text and images indefinitely without requiring processing cycles or otherwise consuming electricity until the image is changed.

For example, the backlighting utilized by conventional electronic displays strains human eyes and is subject to interference and negation by ambient lighting conditions. E-ink is applicable to sheet substrates to form E-paper which reflects ambient light in substantially the same manner as true paper. E-ink displays lightweight, durable, and highly flexible compared to other display technologies and are easier to read at an angle than flat screen monitors.

Using e-ink technology enables bingo display devices such as bingo card 40 to more closely resemble and functionally replicate paper bingo cards which may be a significant actor in determining whether bingo games played with the E-ink displays comply with federal, state, and local laws and regulations relating to gaming classifications. By providing a user-held bingo display forum and including daubing means and control button interactivity, bingo card 40 enables preservation of legally significant aspects of traditional bingo games.

Referring to FIG. 4B, there is depicted a partial cross-section view illustrating the basic structural characteristics of e-ink bingo card 40. E-ink bingo card 40, representative of all or a portion of display assembly 35, comprises display sheet 32 that contains an e-ink display structure which is covered by overlay sheet 38. As explained above with reference to FIG. 3, overlay sheet 38 may comprise a touch screen overlay and/or a protective outer cover layer. As illustrated in the cross-section view, display sheet 32 comprises a display plane 42 supported by a substrate layer 44. Display plane 42 contains the “ink” portion of e-ink in the form of a layer of typically millions of so-called microcapsules, each having a diameter on the order of tens to hundreds of microns. Exemplary of the microcapsules for purposes of the present disclosure is an exemplary microcapsule 55. The microcapsules including microcapsule 55 are disposed in display plane 42 between a pair of opposing electrodes 49 that receive display signals generated by a display controller.

To form display layer 42, the e-ink is deposited onto a thin film that is laminated to a layer of circuitry (not depicted) that forms a pattern of pixels that are controlled by a display controller. The microcapsules are suspended in a liquid carrier medium allowing them to be printed or otherwise fluidly deposited onto the film using existing screen printing processes.

Microcapsules utilized in e-ink applications are characterized in that they form a sealed chamber containing negatively and/or positively polarized particles suspended in a fluid. Several color scheme variations have been developed for e-ink applications. In one application the microcapsules contain both negatively charged white particles and positively charged black particles. Responsive to a region of the bottom electrode applying a negative electric field and an opposing region of the top electrode applying a positive electric field, the white particles move to the top and black particles move to the bottom of the microcapsules between the opposing electrode regions where they become visible to the user. This makes the corresponding surface region appear white. By reversing the electrode polarity, the black particles move to the top of the microcapsules, making the surface region appear dark.

In depicted embodiment, microcapsule 55, representative of the other microcapsules, forms a sealed unit containing a dark (e.g. dark blue) ink in which tens, hundreds, or thousands of light colored (e.g. white) pigmented particles 67 are immersed. While the exemplary microcapsules are described as having white particles and blue ink, numerous alternate ink and particles colors, such as for multicolor displays, may be utilized without departing from the spirit or scope of the present invention. Depending on the electrical polarity across electrodes 49, the particles 67 will either be driven to the top or bottom of each respective microcapsule. When driven to the top, the white pigmented particles cause the respective microcapsules to appear white. When an opposite polarity is applied across electrodes 49, the particles are driven to the bottom so that the corresponding microcapsules assume the color of the dark ink. Patterns of white and dark symbols can then be created in accordance with the electric fields applied to various regions of the display plane 42 to form the letters, numbers, etc. included in the surface display of bingo card 40.

It should be noted that the cross-section view in FIG. 4B is not intended to provide an accurate assessment of relative dimensions (e.g., height versus width), but is intended to provide a convenient and informative view of the constituent internal components of bingo card 40. In a preferred embodiment, the cross section distance through overlay and display sheets 38 and 32 is relatively small, preferably on the order of a few to tens of microns. In this manner, bingo card 40 assumes a thin and flexible contour that can be readily transported, stacked, shuffled, and physically rearranged such as on a bingo table surface. The applicability of e-ink microcapsule display elements on a variety of substantially flexible material surface types such as thin plastic film and/or paper card stock enables the e-ink bingo card display of the present invention to incorporate the flexibility and speed of electronically controlled bingo while retaining many of the advantages of paper bingo cards. A preferred embodiment further addresses challenges relating to the onboard circuit components and connectivity required to control the image while still maintaining a substantially paper-thin sheet contour. To this end, specialized submicron circuit components such as plastic transistors that can be printed onto a paper-thin sheet to provide the adequate charge needed to drive the microcapsule particles sufficiently to change colors.

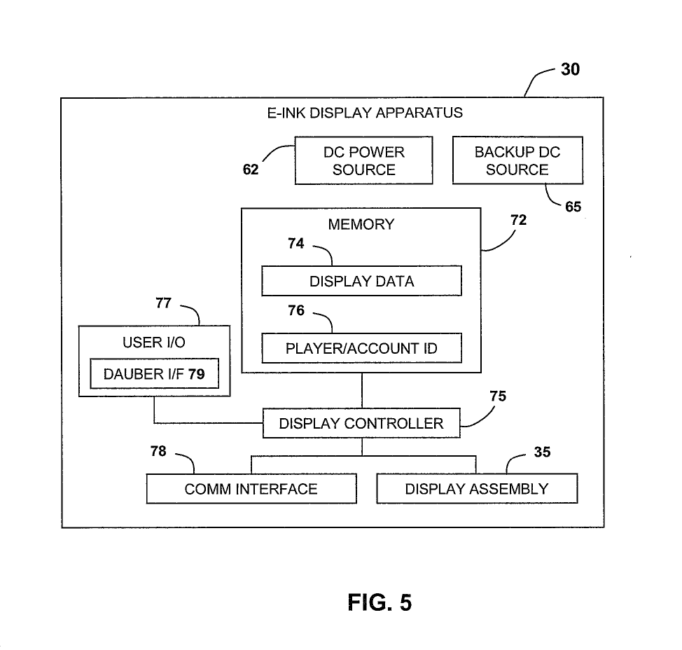

FIG. 5 depicts a high-level block diagram illustrating the internal electronic and logic modules that may be incorporated in e-ink display device 30 in accordance with the present invention. Referring to FIG. 5 in conjunction with FIGS. 1 and 2, e-ink display device 30 includes a display controller 75, memory 72, and a communications interface 78. Memory 72 may comprise volatile and nonvolatile memory elements that store program code and instructions executed by display controller 75 for directly or indirectly executing the various bingo game processing functions provided by display device 30.

Communications interface 78 includes transceiver and signal processing modules that enable wireless and/or wired communications between the display controller 75 within e-ink display device 30 and its respective local controller such as local controller 22, table controller 16, etc., and/or master controller 4. E-ink display device 30 further comprises a user input/output (I/O) interface 77 which enables player participation in the bingo-like games provided through gaming system 10, and dynamically displays intermediate and final game results. User I/O interface 77 preferably includes player controls such as the aforementioned dauber 41 and touch screen or magnetic proximity sensor display arrangement described above with reference to FIGS. 3 and 4B and collectively depicted as dauber interface 79. User I/O interface 77 may include additional features such as audio and tactile outputs, and possibly special alarms or alerting devices.

User I/O interface 77 also preferably includes a card reader, bar code reader, keypad, or other user input mechanism that enables players to input player-specific and/or payment account-specific data for facilitating confirmation and/or receipt of wager amounts and dispensing of winning amounts as well as for player card authorization and authentication. For example, user I/O interface 77 may include a magnetic card reader or biometric reader (not depicted) adapted to read player-specific information from a player account card or the player him or herself. For the embodiment in which user I/O interface 77 is adapted to receive player and/or payment account identity information, such information may be stored in memory 72 as player/account information 76.

Failure of an electronic gaming device during play may result in extremely negative reactions from players who may feel cheated. Therefore, and as previously explained with reference to FIG. 2, display device 30 preferably includes one or more containment features for providing a sealed housing for e-ink display assembly 35. In addition to the use of a protectively sealed housing, the present invention may provide several other reliability features, chief among which is a redundant power supply arrangement. In the depicted embodiment, the display and other electronic modules within e-ink display device 30 are generally supplied by a primary DC power source 62 which may be any one of a variety of electrically, photovoltaically, or inductively rechargeable battery cells. A back-up DC power source 65 is switch-coupled to the power supply arrangement within display device 30 and is automatically switched online to provide operating power when main DC source 62 becomes inadequately charged or otherwise inoperative.

As further depicted in FIG. 5, a set of display data 74 may be stored in memory 72 and accessed by display controller 75 during a bingo game session in which display device 30 is activated. For example, display controller 75 may store display data 74 including encoded representations of the particular bingo face indicia (i.e. numbers or other game indicia contained in the bingo face fields. Display data 74 may further include data dynamically recording the “daubed” or “undaubed” status of each of the indicia.

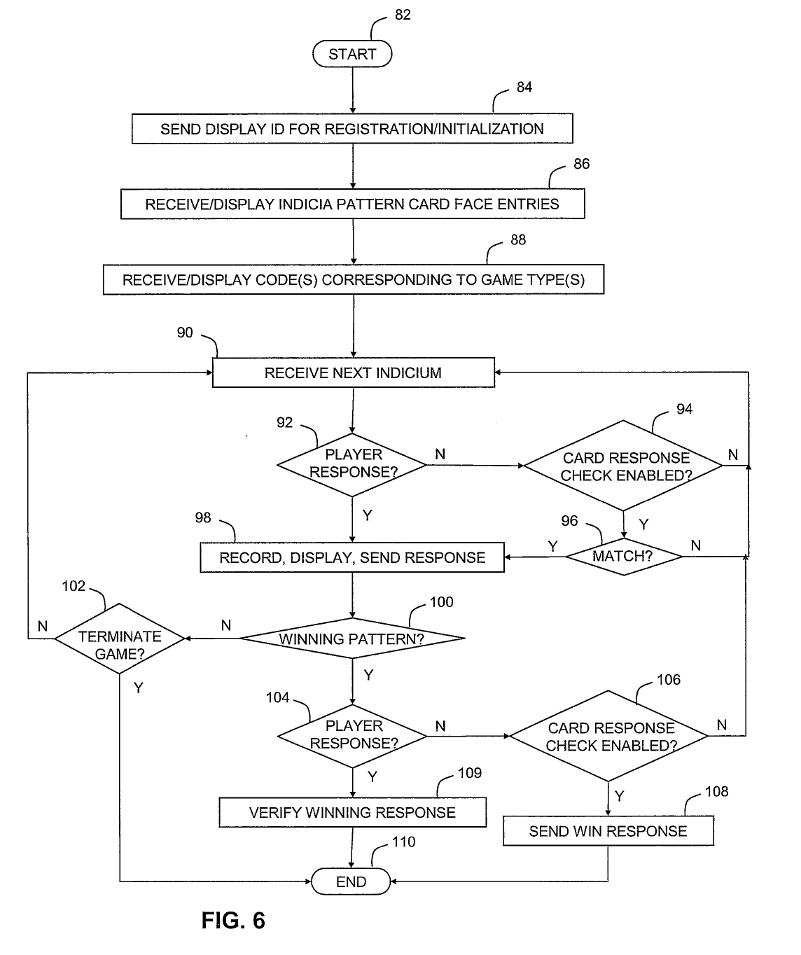

Referring to FIG. 6, there is illustrated a high-level flow diagram depicting steps performed during bingo card display initialization and use in accordance with one embodiment of the present invention. The process begins as illustrated at steps 82 and 84 with an e-ink bingo card display device, such as display device 30, transmitting display device identification data to one of game controllers 22, 16 or 4. The identification data preferably includes an identifier code that the game controller uses to uniquely identify the display device as being legally or otherwise authorized to engage in a specified gaming activity and furthermore distinguishes the display device as being associated with a particular player and/or game account. As depicted in FIG. 1, the transmission of the display device identification data may be performed locally or over a network connecting remote gaming nodes using a wireline and/or wireless connection interfaces.

The display identification data is further used by the game controller to initialize the display device as being a member of a specified bingo game session. As part of a typical initialization, the game controller may issue a “start” or “reset” message to the display device. The controller may then generate one or more of bingo indicia patterns, each corresponding to a separately playable face and downloaded to the display device. As is well known in the art, any combination of generated bingo array indicia patterns must satisfy the condition that no two faces used in the same game have the same array indicia pattern. Once the bingo indicia patterns have been downloaded to the display device and other participating display devices, the game controller may remain substantially idle through the remaining portion of the game session. In an alternate embodiment, and as explained with reference to the following steps, the game controller may perform other game time functions such as random number generation for the indicium calls, wager and payout accounting, etc.

Proceeding as illustrated at step 86, the e-ink display device receives and displays one or more bingo card face indicia patterns sent from one of the game controllers. The indicia patterns generated and sent by the game controller may be the well-known patterns of integers between 1 and 99 entered into each of the array positions in a bingo card representation. In one embodiment, the game controller may generate and send the card face patterns in response to validated requests for one or more card faces delivered by the display device to the controller as part of registration/initialization step 84. In a preferred embodiment, the received bingo card faces are displayed by the display device using an e-ink display assembly as described herein with reference to FIGS. 2-4. In close association with and possibly encompassed within steps 84 and 86, the display device receives data designating the particular type of bingo game type to be played as shown at step 88. The received game-type data may be delivered from the game controller or entered by the player such as via user I/O interface 77. More specifically, the game-type data is utilized by an external or onboard display controller, such as display controller 75 to include in the bingo card face display a color and/or pattern code that visually cues the player to which game is being played on the respective bingo card faces. Such color and/or pattern coding preferably simulates different bingo card colors and patterns printed on paper bingo cards to designate a game within a multi-game session that will be played on each particular card/face.

After initialization and pattern display setting, the bingo game commences with the display device along with other participating devices receiving randomly determined game series indicia (step 90). The game series indicia are typically numbers that are pseudo-randomly generated or otherwise determined by master controller 4 which may also determine, after each call, whether any of the bingo indicia array patterns played by the display device and other participating devices have achieved, or are actually displaying in accordance with user marking, a winning arrangement.

In one embodiment, the game controller may run a pseudo-random number generator routine to generate the sequential indicium calls received by the display device during a bingo game. In a desirable alternative embodiment, the system of the invention such as gaming system 10 may utilize conventional, non-autonomic means of generating called indicia and verifying winning patterns such as by using a human caller and floor walker.

Responsive to or following receipt of each indicium from a game controller or game caller, the display device may or may not receive an indication of a player response, such as when the player daubs a matching indicium entry displayed on the display device. If, following receipt of the indicium from the game controller, a player “daubing” response is detected or otherwise received such as via user I/O interface 77, the display device records, displays, and sends the daubing response to the master game controller (steps 92 and 98).

If, as illustrated at steps 92 and 94, no player daubing response is received following receipt of the indicium, the display device may or may not generate a prompt or backup response depending on whether an automatic response check backup is enabled. Responsive to a backup response check not being enabled, the game processing for the presently received game indicium ends and the process returns to receiving the next sequential indicium at step 90. In response to an automated backup response check being enabled and finding a match (i.e. the player missed a matching pattern entry), the display device records, displays, and sends the appropriate “daubing” response to the master controller as depicted at steps 94, 96, and 98.

As is well known, the play of a game of bingo continues until a player covers or marks a winning pattern of indicia (step 100) and calls bingo or signals bingo using a display mounted control button (step 104). At this point, play stops and the player who called bingo submits his or her winning face to a representative of the game operator for validation of the claimed win. Alternatively, and as shown at step 109 the winning pattern signal may be electronically submitted via the display device and received by the master game controller which verifies whether a winning pattern has been achieved. As depicted in the sequence of steps 100, 102, and 110, if a winning pattern has not been detected or affirmed by the player such as by actuating a display control button such as control button 48, display device, or game controller, the game may be otherwise terminated such as by another player/display device achieving a winning pattern. Otherwise, if a winning pattern has not been achieved by the display device or another device or player, the game continues with the next received game pattern indicium at step 90.

If a winning pattern has been technically achieved and is recognized by the player, the game ends as shown at steps 104 and 110. If a winning pattern is not recognized or otherwise not responded to, such as by a failure to daub the winning pattern entry, the system may detect and send an appropriate win signal to the master controller if an automated response check is enabled (steps 106, 108). Otherwise, as shown at steps 106 and 90 the game continues with the next received indicium.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. An electronic game device comprising:
a display controller adapted for generating a game face; and
a display assembly that displays the generated game face, said display assembly including:
an electronic ink display sheet on which the generated game face is displayed; and
a dauber interface that converts dauber input signals to electronic signals received by said display controller to adjust the display of the game face on said electronic ink display.

2. The electronic game device of claim 1, wherein said display controller is adapted for generating multiple independently playable bingo game card faces.

3. The electronic game device of claim 1, wherein said dauber interface comprises a pressure-sensitive grid addressable to corresponding planar positions on the displayed game face.

4. The electronic game device of claim 3, wherein the displayed game face is a bingo game card face.

5. The electronic game device of claim 1, further comprising a wireless communication interface having transceiver and signal processing means that enable wireless communications between said display controller and a remote master game controller that issues control instructions for multiple game participants.

6. The electronic game device of claim 1, wherein said display assembly comprises a substantially flexible layered planar member having multiple layers including:
said electronic ink display sheet; and
an overlay sheet disposed over and covering said electronic ink display sheet, said overlay sheet forming a touch sensitive input interface for said dauber interface.

7. The electronic game device of claim 6, wherein said electronic ink display sheet comprises a flexible substrate sheet layer supporting a display plane layer.

8. The electronic game device of claim 7, wherein said display plane layer comprises:
a pair of opposing electrodes that receive display signals generated by said display controller; and
multiple electronic ink microcapsules disposed in a plane between said pair of opposing electrodes.

9. The electronic game device of claim 8, wherein each of said electronic ink microcapsules comprises a sealed unit containing a pigmented fluid in which multiple pigmented particles are immersed, and wherein the pigmentation of the multiple particles visually contrasts with the pigmentation of the contained fluid.

10. The electronic game device of claim 1, wherein said display assembly includes a winning pattern control button that is selectable using said dauber interface, wherein selection of said winning pattern control button sends a winning pattern signal prompt to a game controller.

11. The electronic game device of claim 1, wherein said display assembly includes an unmark control button that is selectable using said dauber interface for removing both a visual indication of and an underlying game controller recordation of an incorrectly daubed indicium on the displayed game face.

12. The electronic game device of claim 1, further comprising a memory device storing player information.

13. An electronic bingo gaming system comprising:
an electronic ink display card displaying at least one bingo card face, wherein said electronic ink display card includes:
an electronic ink display sheet comprising a flexible substrate sheet layer supporting a display plane layer, wherein said display plane layer comprises:
a pair of opposing electrodes that receive display signals generated by said display controller; and
multiple electronic ink microcapsules disposed in a plane between said pair of opposing electrodes, wherein each of said electronic ink microcapsules comprises a sealed unit containing a pigmented fluid in which multiple pigmented particles are immersed, and wherein the pigmentation of the multiple particles visually contrasts with the pigmentation of the contained fluid; and
an overlay sheet disposed over and covering said electronic ink display sheet, said overlay sheet forming a pressure sensitive dauber user input interface input interface; and
a game controller having game server functionality and communicatively coupled to said electronic ink display card, wherein said game controller generates bingo game indicia calls.

14. The electronic bingo gaming system of claim 13, wherein said game controller further includes point-of-sale functionality for receiving and managing bingo card sales information.

15. The electronic bingo gaming system of claim 13, wherein said electronic ink display card further comprises a wireless communication interface for communicating with said game controller.

16. The electronic bingo gaming system of claim 13, wherein said electronic ink display card displays multiple independently playable bingo card faces.

17. The electronic bingo gaming system of claim 13, wherein said electronic ink display card further includes a portable battery power supply.

18. The electronic bingo game system of claim 13, further comprising a display table having display card interfaces for communicatively interfacing multiple electronic ink display cards with a local game controller.
